(19) United States
(12) Patent Application Publication
(10) Pub. No.: US 2013/0336544 A1
(43) Pub. Date: Dec. 19, 2013

(54) INFORMATION PROCESSING APPARATUS AND RECORDING MEDIUM

(71) Applicant: SONY CORPORATION, Tokyo (JP)

(72) Inventors: YOICHIRO SAKO, Tokyo (JP); TAKATOSHI NAKAMURA, Kanagawa (JP); AKIRA TANGE, Tokyo (JP)

(21) Appl. No.: 13/911,498

(22) Filed: Jun. 6, 2013

(30) Foreign Application Priority Data
Jun. 15, 2012 (JP) 2012-135671

(51) Int. Cl. G06K 9/00

(52) U.S. Cl. CPC G06K 9/00362
USPC 382/115

(57) ABSTRACT

There is provided an information processing apparatus including a first managing unit that manages specific person information, the specific person information being information regarding a specific person, a second managing unit that manages attention object information, the attention object information being information regarding an attention object candidate, a searching unit that searches for the specific person information, using the attention object information as a search key, an evaluating unit that evaluates an attention object, on the basis of a search result obtained by the searching unit, and a storage control unit that stores the specific person, the attention object, and an evaluation value obtained by the evaluating unit in association with each other.

### BACKGROUND

The present disclosure relates to an information processing apparatus and a recording medium.

Recently, various technologies for executing specific information processing on the basis of preferences of users have been disclosed. For example, technology for evaluating existing customers and new customers comprehensively on the basis of preferences of customers has been disclosed in JP 2004-185147A.

Further, technologies for enabling users to read advertisement information of units of “stores” according to preferences of the users have been disclosed in JP 2002-203169A, JP 2002-203170A, and JP 2002-203171A.

Further, technology for constructing a high-reliability person database using reliability evaluated for each category and using information provided by a person having high reliability has been disclosed in WO 2002-099695.

### SUMMARY

However, in JP 2004-185147A, JP 2002-203169A, JP 2002-203170A, and JP 2002-203171A and WO 2002-099695, a system for evaluating favorite stores or commercial products of celebrities such as an entertainer, an athlete, a cultured person, and a politician whom a user likes and proving information on the basis of evaluation values is not constructed.

It is desirable to provide an information processing apparatus and a recording medium that can provide favorite information of a specific person, on the basis of evaluations with respect to attention object candidates.

According to an embodiment of the present disclosure, there is provided an information processing apparatus including a first managing unit that manages specific person information, the specific person information being information regarding a specific person, a second managing unit that manages attention object information, the attention object information being information regarding an attention object candidate, a searching unit that searches for the specific person information, using the attention object information as a search key, an evaluating unit that evaluates an attention object, on the basis of a search result obtained by the searching unit, and a storage control unit that stores the specific person, the attention object, and an evaluation value obtained by the evaluating unit in association with each other.

According to an embodiment of the present disclosure, there is provided a recording medium having a program recorded thereon, the program causing a computer to execute a process of managing specific person information, the specific person information being information regarding a specific person, a process of managing attention object information, the attention object information being information regarding an attention object candidate, a process of searching for the specific person information, using the attention object information as a search key, a process of evaluating an attention object, on the basis of a search result obtained in the process of searching for the specific person information, and a process of storing the specific person, the attention object, and an evaluation value obtained in the process of evaluating the attention object in association with each other.

According to the embodiments of the present disclosure described above, favorite information of a specific person can be provided, on the basis of evaluations with respect to attention object candidates.

### BRIEF DESCRIPTION OF THE DRAWINGS

FIG. 1 is a diagram illustrating an outline of a favorite information acquisition system according to an embodiment of the present disclosure;

FIG. 2 is a block diagram illustrating a configuration of a client terminal according to this embodiment;

FIG. 3 is a block diagram illustrating a configuration of a server according to this embodiment;

FIG. 4 is a diagram illustrating an example of data that is stored in a specific person information DB according to this embodiment;

FIG. 5 is a diagram illustrating an example of data that is stored in an attention object candidate information DB according to this embodiment;

FIG. 6 is a diagram illustrating search processing executed by a searching unit according to this embodiment;

FIG. 7 is a flowchart illustrating operation processing of a favorite information acquisition system according to this embodiment;

FIG. 8 is a transition diagram of a screen in a favorite information acquisition system according to this embodiment;

FIG. 9 is a diagram illustrating a display example based on favorite information according to this embodiment;

FIG. 10 is a diagram illustrating another display example based on favorite information according to this embodiment;

FIG. 11 is a diagram illustrating a guidance example of a favorite store according to this embodiment; and

FIG. 12 is a diagram illustrating a display example of favorite commercial products according to this embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.
1. Outline of Favorite Information Acquisition System according to Embodiment of Present Disclosure
2. Basic Configuration

2-1. Configuration of Client Terminal

2-2. Configuration of Server
3. Operation Processing
4. Conclusion

### <1. OUTLINE OF FAVORITE INFORMATION ACQUISITION SYSTEM ACCORDING TO EMBODIMENT OF PRESENT DISCLOSURE>

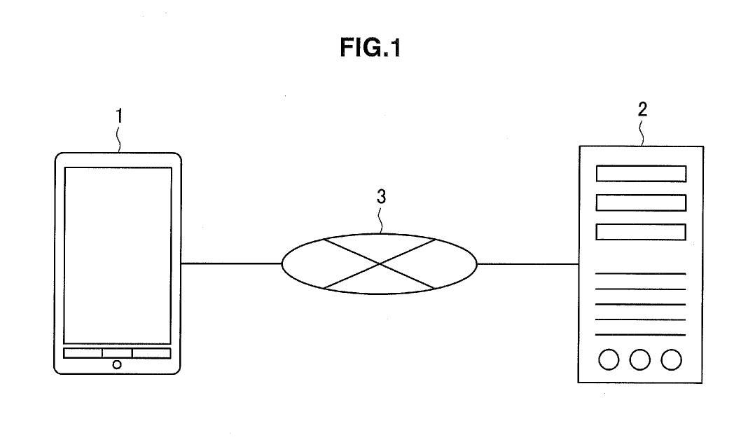

First, an outline of a favorite information acquisition system according to an embodiment of the present disclosure will be described with reference to FIG. 1. As illustrated in FIG. 1, the favorite information acquisition system according to the embodiment of the present disclosure includes a client terminal 1 and a server 2. The client terminal 1 and the server 2 are connected to each other through a network 3 and transmit/receive data.

The demand for providing information regarding favorite stores or commercial products of celebrities such as an entertainer, an athlete, a cultured person, and a politician is high and commercial products labeled as “OO favorite” are often sold. If a user is a fan, the user desires to visit a store that a favorite celebrity recommends or visits often and share the same experience with the favorite celebrity or has a dream or hope and an expectation of meeting the favorite celebrity if the user goes to the store.

However, a system for providing a favorite store or commercial product of a favorite celebrity of the user is not constructed.

For example, in JP 2004-185147A, favorite information of a celebrity is provided as information in a free paper or a piece of content provided to a user. However, JP 2004-185147A does not disclose how the favorite information of the celebrity is generated.

In JP 2002-203169A, JP 2002-203170A, and JP 2002-203171A, if a user clicks a celebrity favorite mark displayed in association with advertisement information, the advertisement information selected by the celebrity is displayed. However, a standard used when the celebrity selects such advertisement information is unclear. For example, it is assumed that the advertisement information is advertisement information of a maker which the celebrity contracts, advertisement information selected only to confirm content, or advertisement information which has been interesting before, but is uninteresting at the present time. Therefore, a store or a commercial product that is shown by each advertisement information displayed as the celebrity favorite is not necessarily a recent favorite store of the celebrity or a commercial product which the celebrity likes and uses.

In WO 2002-099695, technology for evaluating a store or a commercial product on the basis of favorite information of a celebrity is not disclosed.

Therefore, the inventors have come to develop the favorite information acquisition system according to the embodiment of the present disclosure in view of the above circumstances. The favorite information acquisition system according to the embodiment of the present disclosure searches for information regarding a specific person designated by a user in the client terminal 1 and evaluates attention object candidates such as a store or a commercial product, so that the favorite information acquisition system can provide information (favorite information) regarding attention objects of the specific person. Hereinafter, the client terminal 1 and the server apparatus 2 that are included in the favorite information acquisition system according to the embodiment of the present disclosure will be sequentially described in detail.

FIG. 1 illustrates a smart phone as an example of the client terminal 1. However, the client terminal according to the embodiment of the present disclosure is not limited thereto. For example, the client terminal may be a PC (Personal Computer), a PDA (Personal Digital Assistants), a mobile phone, a digital camera, a car navigation apparatus, a tablet terminal, a portable music reproducing apparatus, a portable video processing apparatus, or a portable game machine.

### <2. BASIC CONFIGURATION>

### [2-1. Configuration of Client Terminal]

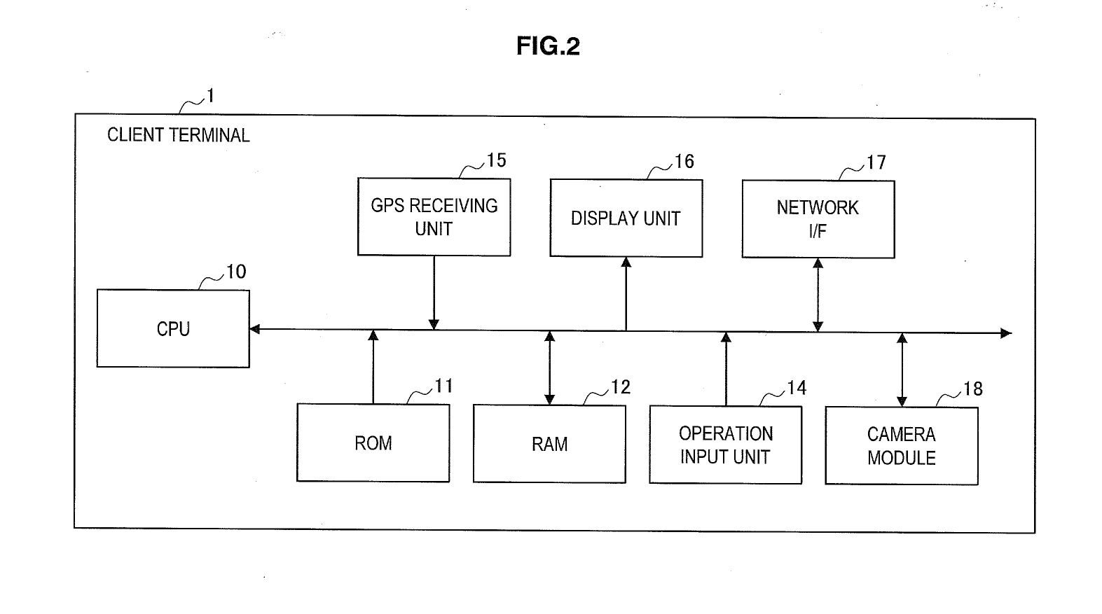

FIG. 2 is a block diagram illustrating a configuration of the client terminal 1 according to this embodiment. As illustrated in FIG. 2, the client terminal 1 according to this embodiment includes a CPU 10, a ROM 11, a RAM 12, an operation input unit 14, a GPS receiving unit 15, a display unit 16, a network I/F 17, and a camera module 18.

The CPU 10 is a control unit that controls each configuration of the client terminal 1. The CPU 10 reads various programs stored in the ROM 11 to be described below and performs various control using the RAM 12 as a work area.

For example, the CPU 10 according to this embodiment performs control to request the server 2 to transmit the favorite information of the specific person designated by the user, according to an operation signal output from the operation input unit 14. Specifically, the CPU 10 performs control such that a full name of the specific person input by the user or current position information acquired by the GPS receiving unit 15 is transmitted from the network I/F 17 to the server 2.

In this case, the specific person in the present disclosure is a person that is specified by the user and includes a celebrity such as an entertainer, an athlete, a cultured person, and a politician and a person such as a minor entertainer who is not famous throughout a whole country area, but is known throughout a partial area.

The CPU 10 according to this embodiment has a function of a display control unit that performs control, such that a favorite store or commercial product (attention object) of the specific person is displayed on the display unit 16, on the basis of the search result of the favorite information of the specific person received from the server 2.

The RAM (Random Access Memory) 11 and the ROM (Read Only Memory) 12 are storage media that are used when the CPU 10 operates. For example, the RAM 12 is used as a work area of the CPU 10 and the ROM 11 stores a program to execute control of the CPU 10 to request the server 2 to transmit the favorite information of the specific person or display control performed by the CPU 10 on the basis of the search result.

The operation input unit 14 detects an operation input from the user and outputs the operation input as an operation signal to the CPU 10. The operation input unit 14 may be realized by a button having a physical configuration or a touch panel detecting an operation input from the user with respect to a button displayed on a screen.

The GPS (Global Positioning System) receiving unit 15 has a function of acquiring current position information of the client terminal 1. Specifically, the GPS receiving unit 15 receives navigation messages transmitted from three or more artificial satellites and can measure a current position on the basis of the received navigation messages. The position information that is acquired by the GPS receiving unit 15 may be transmitted to the server 2 when the CPU 10 requests for the favorite information of the specific person.

The display unit 16 is a display device such as a liquid crystal display (LCD) device or an OLED (Organic Light Emitting Diode) device. The display unit 16 according to this embodiment displays a favorite store or commercial product (attention object) of the specific person, according to the display control by the CPU 10.

The network I/F 17 is a communication interface for connection with another communication apparatus. The network I/F 17 can be connected to another communication apparatus by wire or wireless. Specifically, the network I/F 17 according to this embodiment is connected to the server 2 through the network 3 and requests for searching for the favorite information of the specific person, according to the control by the CPU 10. The network I/F 17 receives the search result from the server 2 and outputs the received search result to the CPU 10.

The camera module 18 includes an imaging element, an imaging optical system including an imaging lens, and a captured image signal processing unit and outputs captured image data converted into a digital signal. The imaging element is realized by a CCD (Charge Coupled Device) imager or a CMOS (Complementary Metal Oxide Semiconductor) imager.

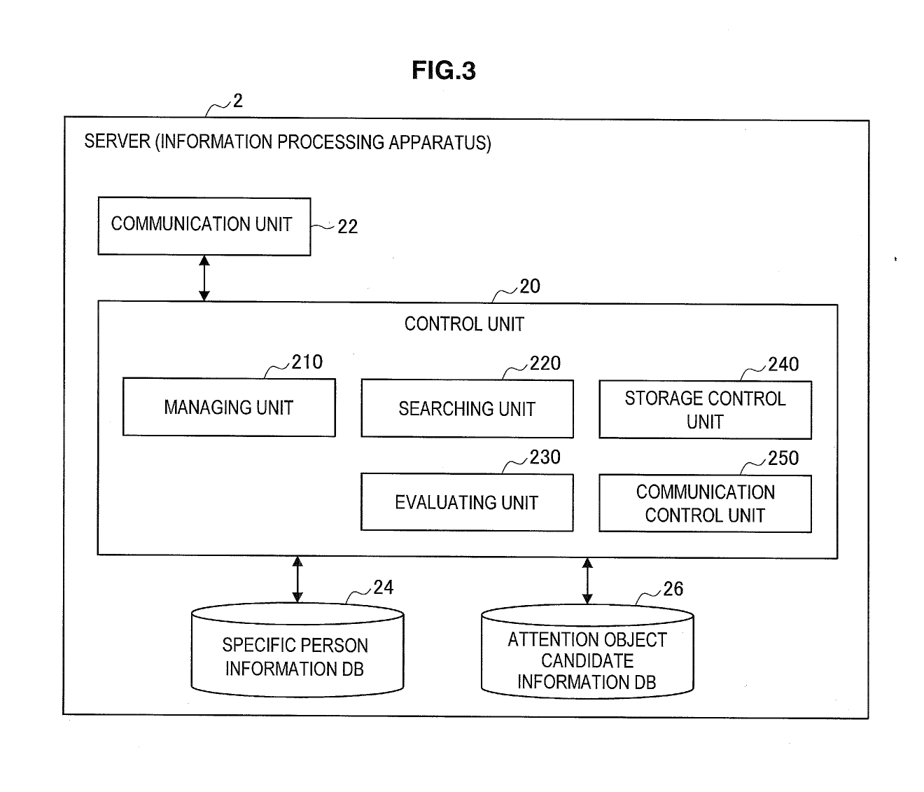

Each configuration of the client terminal 1 according to this embodiment has been described. Next, a configuration of the server 2 (information processing apparatus) according to this embodiment will be described with reference to FIG. 3.

### [2-2. Configuration of Server]

FIG. 3 is a block diagram illustrating a configuration of the server 2 according to this embodiment. As illustrated in FIG. 3, the server 2 includes a communication unit 22, a control unit 20, a specific person information DB (Database) 24, and an attention object candidate information DB (Database) 26.

### (Communication Unit 22)

The communication unit 22 has a function of being connected to an external communication apparatus and transmitting/receiving data. Specifically, the communication unit 22 according to this embodiment receives the favorite information search request from the client terminal 1 and transmits the search result in the server 2 to the client terminal 1 in response to the search request.

### (Specific Person Information DB 24)

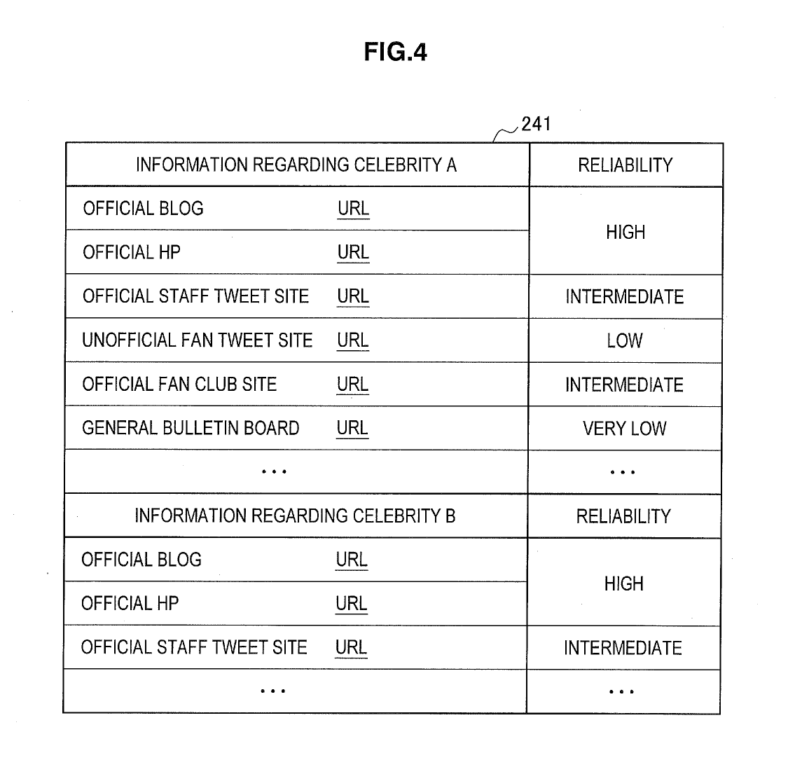

The specific person information DB 24 is a storage unit that stores information regarding the specific person. The information regarding the specific person (specific person information) includes information disclose to a Web page by the specific person or information disclose to a Web page by a participator. FIG. 4 illustrates an example of the information regarding the specific person that is stored in the specific person information DB 24.

As illustrated in FIG. 4, specific person information 241 may be an address (URL) of a Web page provided by the information regarding the specific person and reliability (weighting) of information is associated with each URL. As for the reliability, reliability of information provided (transmitted) by the specific person is highest and reliability of information transmitted by people (participators such as staffs) around the specific person is second high. Further, reliability of information that is transmitted by a fan is low and reliability of information that is transmitted by a general user is lowest.

### [Attention Object Candidate Information DB 26]

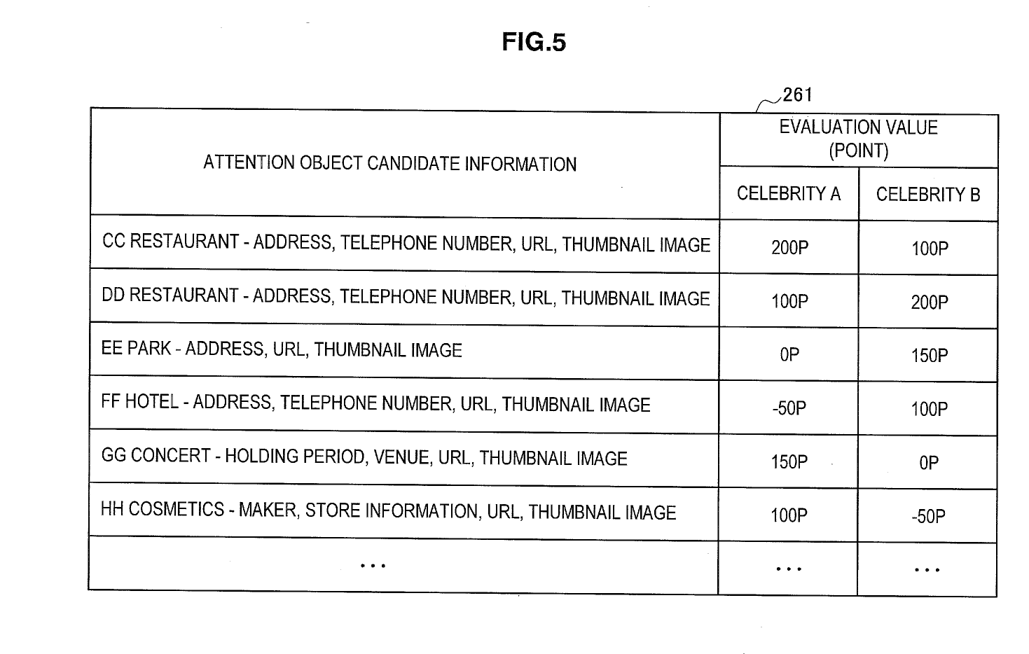

The attention object candidate information DB 26 is a storage unit that stores information regarding attention object candidates. The information regarding the attention object candidates is information of object candidates such as store information, commercial production information, event information, and spot information to which a person can pay attention. FIG. 5 illustrates an example of information regarding a specific person that is stored in the attention object candidate information DB 26.

As illustrated in FIG. 5, information 261 regarding attention object candidates includes a name, an address, a telephone number, a URL, and a thumbnail image of each store, a maker, store information (a name, an address, and the like), a URL, and a thumbnail image of each commercial product, and a holding period, a venue, a URL, and a thumbnail image of each event. Each of the attention object candidates is associated with an evaluation value for each of the specific persons. The evaluation value is a value that is calculated by an evaluating unit 230 to be described below. When the evaluation value is more than a predetermined value, the corresponding attention object candidate is determined as an attention object of the specific person.

### (Control Unit 20)

The control unit 20 has a function of controlling each configuration of the server 2. The control unit 20 according to this embodiment has a managing unit 210, a searching unit 220, an evaluating unit 230, a storage control unit 240, and a communication control unit 250, as illustrated in FIG. 3.

### Managing Unit 210

The managing unit 210 has a function of managing the specific person information DB 24 and a function of managing the attention object candidate information DB 26. Specifically, the managing unit 210 may continuously collect information regarding a person specified by the user in the client terminal 1 or an address of a Web page providing the information regarding the specific person on the network and store the information or the address in the specific person information DB 24. The managing unit 210 associates the reliability, according to a sender (provider) of the collected information.

The managing unit 210 may continuously collect the information regarding the attention object candidates using the URLs of the attention object candidates (addresses of the Web pages of the store, the event, the commercial product, and the spot) stored in the attention object candidate information DB 26 and store the information in the attention object candidate information DB 26.

### Searching Unit 220

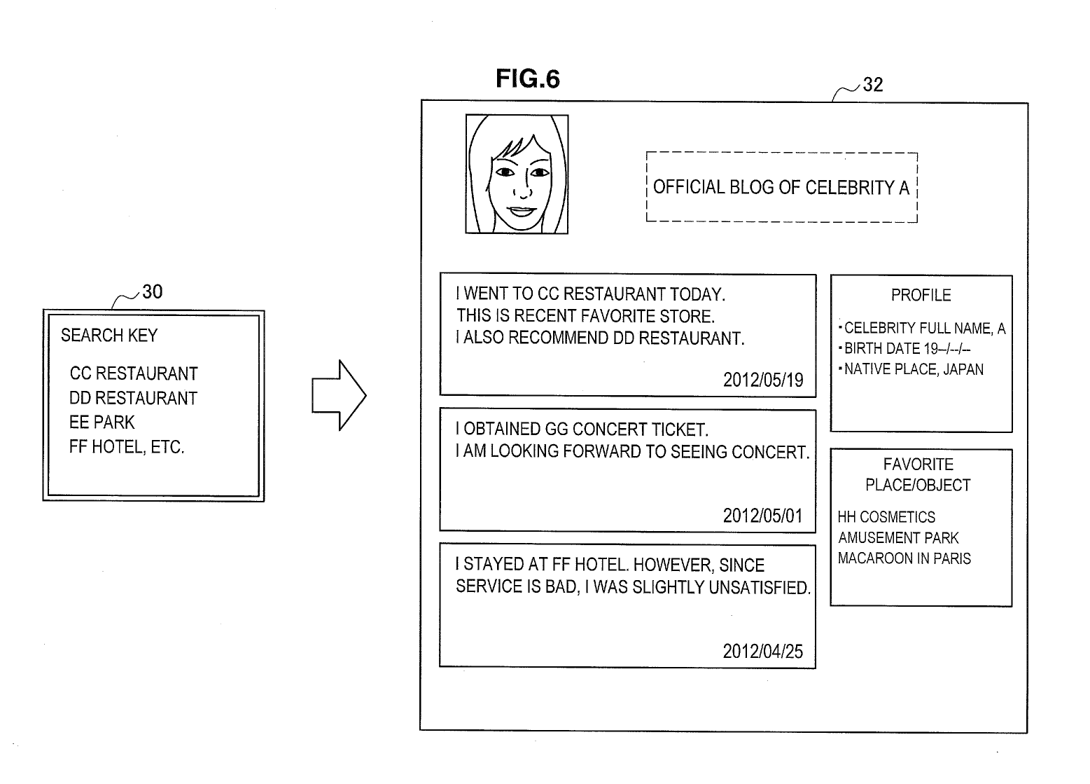

The searching unit 220 searches for the information regarding the specific person (recommendation/use history of the attention objects in the information regarding the specific person), using the attention object candidate information as a search key. When the URLs are stored in the specific person information DB 24, the searching unit 220 searches for the attention objects from the Web pages shown by the URLs. FIG. 6 is a diagram illustrating search processing executed by the searching unit 220.

As illustrated in FIG. 6, the searching unit 220 searches a Web page (blog) 32 of a celebrity A shown by the URL stored in the specific person information DB 24, using names “CC restaurant”, “DD restaurant”, and “EE park” of the attention object candidates stored in the attention object candidate information DB 26 as search keys.

For example, the searching unit 220 performs morphological analysis with respect to a sentence disclosed to the Web page 32 and extracts search keys. In the example illustrated in FIG. 6, the searching unit 220 can extract “CC restaurant”, “DD restaurant”, “GG concert”, and “FF hotel” matched with the search keys. The searching unit 220 outputs the search result to the evaluating unit 230.

### Evaluating Unit 230

The evaluating unit 230 has a function of evaluating an attention object, on the basis of the search result output from the searching unit 220. For example, the evaluating unit 230 calculates the evaluation value (points), on the basis of the search (appearing) number of times or frequency of a name of the attention object candidate in content of the blog of the specific person. At this time, the evaluating unit 230 may perform weighting according to the reliability of the specific person information of the search object and calculate the evaluation value. Therefore, an evaluation value of the attention object in which the appearing number of times of the name in the blog of the specific person having the high reliability is large becomes high. The evaluating unit 230 may calculate an evaluation value with respect to recent information high.

The evaluating unit 230 may calculate an evaluation value in consideration of the morphological analysis result of the sentences around the search keys used by the searching unit 220. For example, the evaluating unit 230 performs a plus evaluation if positive and performs a minus evaluation if negative, on the basis of the morphological analysis result of the sentences around the search keys.

In the example illustrated in FIG. 6, because the “CC restaurant” is a “recent favorite store” of a celebrity A, the evaluating unit 230 performs a plus evaluation with respect to the “CC restaurant”. Further, because the “DD restaurant” is “recommended” by the celebrity A, the evaluating unit 230 performs a plus evaluation with respect to the “DD restaurant”. In this case, because the evaluating unit 230 evaluates the attention object of the celebrity A higher, the evaluating unit 230 performs a high evaluation with respect to the “CC restaurant”, which can be determined as a recent favorite store of the celebrity A in actuality, as compared with the “DD restaurant” which is recommended by the celebrity A, but in which it is unclear whether the corresponding restaurant is the favorite store of the celebrity A. The evaluating unit 230 performs a minus evaluation with respect to the “FF hotel”, because the celebrity A is “slightly unsatisfied” with the “FF hotel”.

### Storage Control Unit 240

The storage control unit 240 has a function of associating an evaluation value for each attention object evaluated by the evaluating unit 230 with a specific person and an attention object and storing an association result. For example, the storage control unit 240 may associate an evaluation value with respect to an attention object of each specific person with an attention object stored in the attention object candidate information DB 26 and store an association result (refer to FIG. 5).

### Communication Control Unit 250

The communication control unit 250 has a function of performing control, such that information regarding an attention object of a specific person designated by a user is transmitted to the client terminal 1, according to a favorite search request from the client terminal 1.

Specifically, the communication control unit 250 determines the attention object candidate in which evaluation values (refer to FIG. 5) with respect to the attention object candidates of the celebrity A designated by the user are equal to or more than a predetermined value as the attention object of the celebrity A. The communication control unit 250 transmits information (the name, the thumbnail image, and the like of the attention object) to display the attention object of the celebrity A or information (address and the like) to guide the user to the attention object of the celebrity A from the communication unit 22 to the client terminal 1 through the network 3.

The communication control unit 250 may transmit information (the name, the address, the thumbnail image, and the like of the attention object) to display the attention object of the celebrity A on a map, to the client terminal 1. The communication control unit 250 may transmit information (the name, the thumbnail image, the instruction of the display aspect, and the like of the attention object) to display the attention object of the celebrity A displayed with a different aspect according to whether the evaluation value is more than a first predetermined value or is more than a second predetermined value, to the client terminal 1.

### <3. OPERATION PROCESSING>

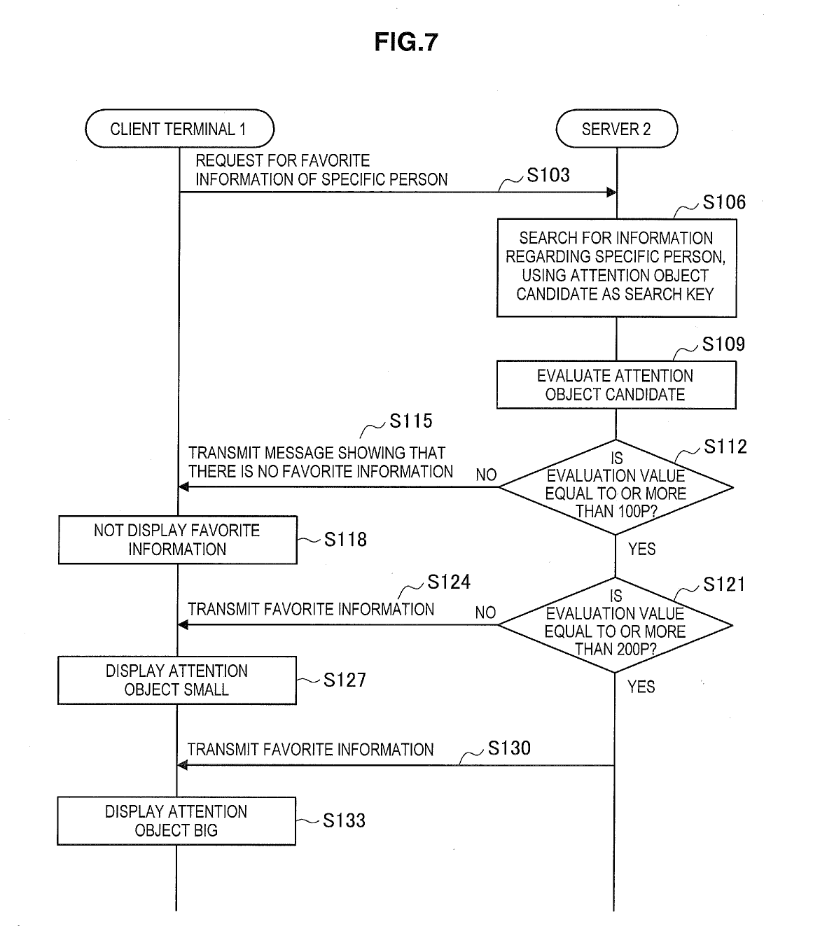

Next, operation processing of the favorite information acquisition system according to this embodiment will be described with reference to FIG. 7. FIG. 7 is a flowchart illustrating operation processing of the favorite information acquisition system according to this embodiment.

As illustrated in FIG. 7, first, in step S103, the client terminal 1 requests for acquiring favorite information of the specific person designated by the user.

Next, in step S106, the searching unit 220 of the server 2 searches for information regarding the specific person designated by the user, using the attention object candidate as the search key, according to the favorite information acquisition request from the client terminal 1.

Next, in step S109, the evaluating unit 230 of the sever 2 evaluates the attention object candidate, on the basis of the search result obtained by the search unit 220.

Next, in step S112, the communication control unit 250 of the server 2 determines whether there is an attention object candidate of which an evaluation value is equal to or more than the first predetermined value (for example, 100 points).

Next, when it is determined that there is not the attention object candidate of which the evaluation value is equal to or more than 100 points (S112/No), in step S115, a message showing that there is no favorite information is transmitted.

In this case, in step S118, the CPU 10 (display control unit) of the client terminal 1 may not display the favorite information and may display “there is no favorite information” on the display unit 16.

Meanwhile, when it is determined that there is the attention object candidate of which the evaluation value is equal to or more than 100 points (S112/Yes), in step S121, the communication control unit 250 of the server 2 determines whether there is an attention object candidate of which an evaluation value is more than the second predetermined value (for example, 200 points). In this case, the second predetermined value is set to be larger than the first predetermined value.

Next, when it is determined that there is not the attention object candidate of which the evaluation value is equal to or more than 200 points (S121/No), in step S124, the communication control unit 250 of the server 2 determines the attention object candidate of which the evaluation value is 100 points or more as the attention object of the specific person. The communication control unit 250 transmits information regarding the attention object of the specific person as the favorite information to the client terminal 1.

Next, in step S127, the client terminal 1 displays the attention object of the specific person small on the display unit 16, on the basis of the favorite information transmitted from the server 2. The favorite information includes information to display the attention object of the specific person, such as the name, the thumbnail image, the instruction (display small) of the display aspect, and the like of the attention object of the specific person.

Meanwhile, when it is determined that there is the attention object candidate of which the evaluation value is equal to or more than 200 points (S121/Yes), in step S130, the communication control unit 250 of the server 2 determines the attention object candidate of which the evaluation value is equal to or more than 200 points as the attention object of the specific person. The communication control unit 250 transmits information regarding the attention object of the specific person as the favorite information to the client terminal 1.

Next, in step S133, the client terminal 1 displays the attention object of the specific person big on the display unit 16, on the basis of the favorite information transmitted from the server 2. The favorite information includes information to display the attention object of the specific person, such as the name, the thumbnail image, the instruction (display big) of the display aspect, and the like of the attention object of the specific person.

The operation processing of the favorite information acquisition system according to this embodiment has been described. When the specific person is registered in advance by the user, the server 2 may continuously execute the processing of steps S106 to S109 described above and continuously update the evaluation value of the specific person with respect to the attention object candidate.

### (Complement 1)

Next, a display screen when the client terminal 1 displays the favorite information of the specific person acquired from the server 2 in steps S127 and S133 described above will be complementarily described below.

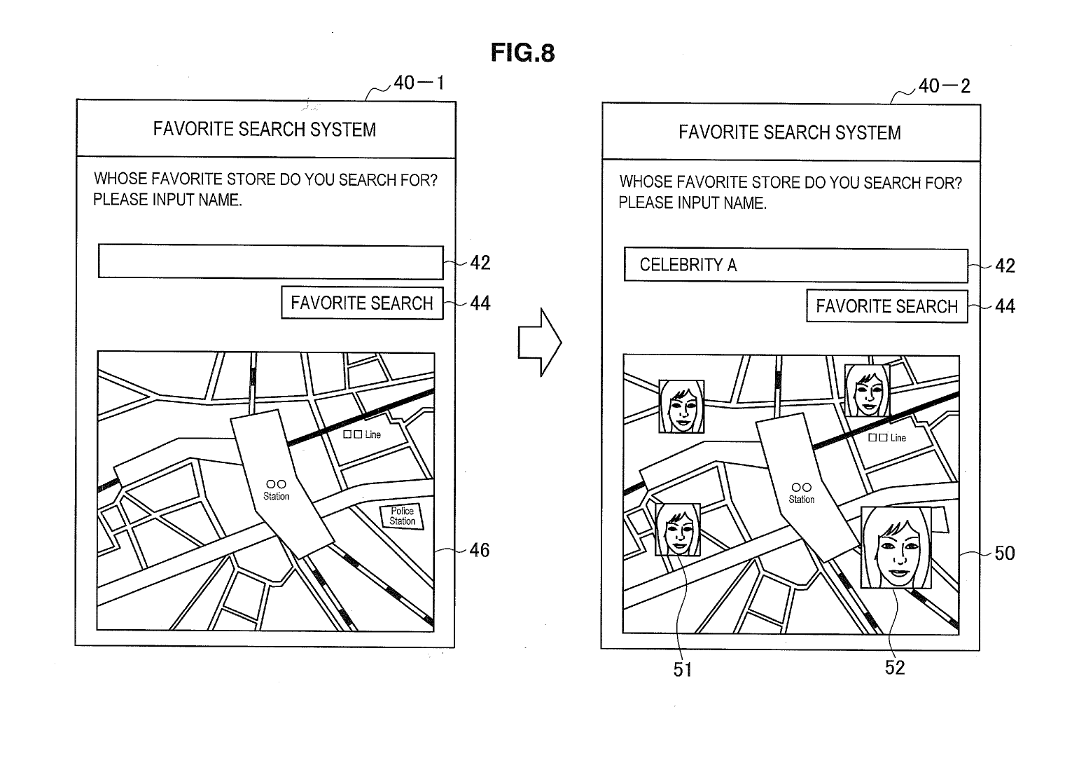

FIG. 8 is a transition diagram of a screen in the favorite information acquisition system according to this embodiment. First, the CPU 10 of the client terminal 1 displays a start screen 40-1 of the favorite information acquisition system (also called a favorite search system) illustrated on the left side of FIG. 8 on the display unit 16. As illustrated in FIG. 8, the start screen 40-1 includes an input region 42 to input a full name of a specific person, a favorite search button 44, and a map display region 46. The user inputs the full name of the favorite specific person to the input region 42 and touches the favorite search button 44, so that the acquisition processing of the favorite store information can be started. In the map display region 46, a map of a peripheral region of the current position is displayed on the basis of the current position information acquired by the GPS receiving unit 15 of the client terminal 1.

A result screen 40-2 that is illustrated on the right side of FIG. 8 is a display screen when a “celebrity A” is input as the full name of the specific person to the input region 42 and the favorite search button 44 is touched. Specifically, first, the client terminal 1 transmits the full name “celebrity A” of the specific person input by the user to the server 2 and requests for acquiring the favorite information (refer to step S103 described above). At this time, the client terminal 1 may transmit the current position information acquired by the GPS receiving unit 15 to the server 2.

Next, the server 2 determines the favorite store of the “celebrity A” designated by the user, on the basis of the evaluation value, according to the acquisition request from the client terminal 1, as described above (refer to steps S106 to S121 described above). In this case, when the current position information is transmitted from the client terminal 1, the communication control unit 250 of the server 2 may determine a store existing near the current position of the client terminal 1 among the stores of which the evaluation values are more than the predetermined value, as the favorite store.

The CPU 10 of the client terminal 1 that has acquired the favorite store information from the server 2 displays the result screen 40-2 illustrated on the right side of FIG. 8 on the display unit 16. In the result screen 40-2, in the map display region 50, face images 51 and 52 of the celebrity A included in the favorite store information are displayed to correspond to addresses (positions) of the favorite stores on the map.

The CPU 10 may perform control to display the face images 51 and 52 with different sizes, according to the instruction of the display aspect included in the favorite store information (steps S217 and S133 described above). For example, the CPU 10 displays the face image 52 to be bigger than the face image 51 as illustrated in FIG. 8, according to the instruction of the display aspect, so that the user can know intuitively that the favorite store shown by the face image 52 is a store that is likely to be a favorite store of the celebrity A.

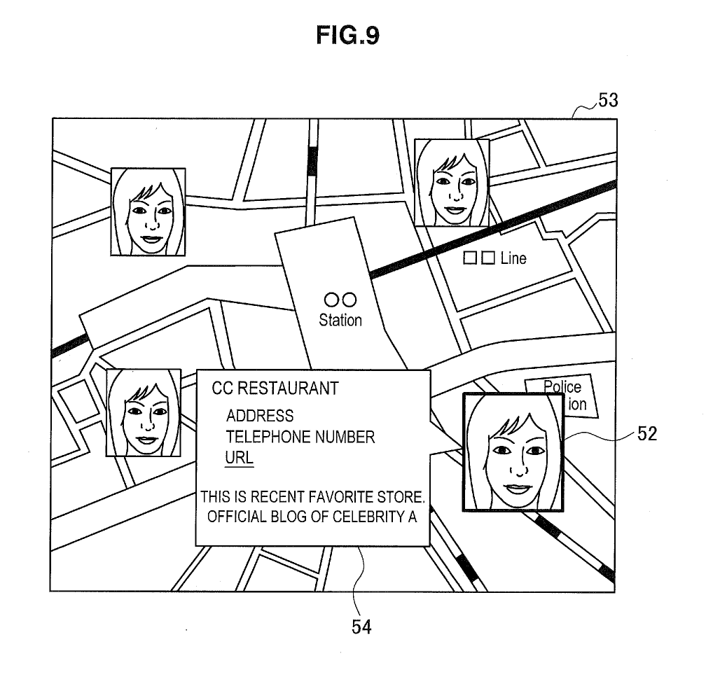

The CPU 10 may display detailed information of each favorite store, when the face image shown on the map is selected. For example, as illustrated in FIG. 9, if the face image 52 is selected, the CPU 10 displays detailed information such as a store name or an address of the favorite store shown by the face image 52, by a balloon display 54. The CPU 10 may display writing content of the celebrity A with respect to the corresponding store as the detailed information, as shown by the balloon display 54 of FIG. 9.

### (Complement 2)

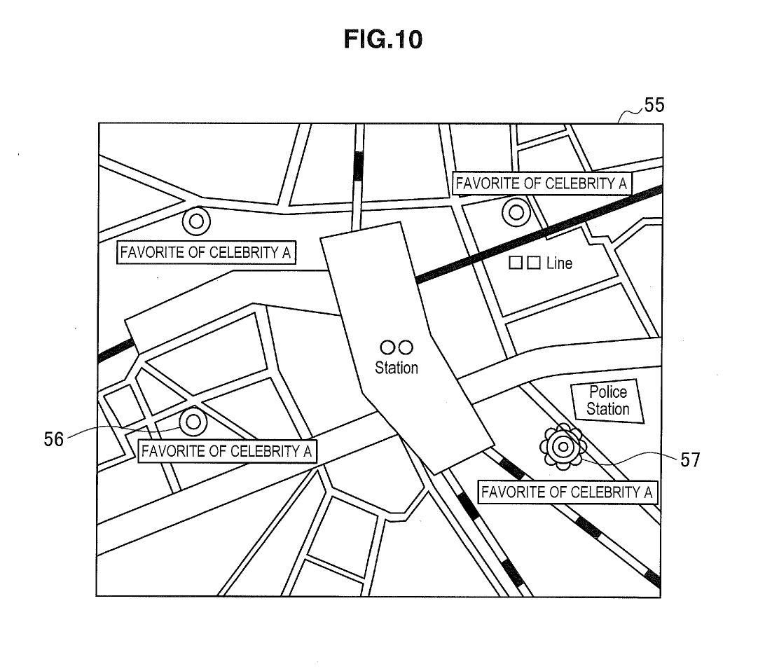

The screen display example when the favorite information is displayed in the client terminal 1 has been specifically described. The screen display example according to this embodiment is not limited to the screen displaying the face images 51 and 52 of the specific person, as in the result screen 40-2 illustrated in FIG. 8. For example, the CPU 10 according to this embodiment may display displays showing the favorites of the specific person and marks, at the positions on the map where the favorite stores exist, which will be described below with reference to FIG. 10.

The CPU 10 of the client terminal 1 may display a map display region 55 illustrated in FIG. 10 as a result screen. In the map display region 55 illustrated in FIG. 10, displays and marks 56 and 57 of “favorites of the celebrity A” are displayed to correspond to addresses (positions) of favorite stores on the map.

The CPU 10 may perform control to display the marks 56 and 57 with marks of different aspects, according to an instruction of a display aspect included in the favorite information, as illustrated in FIG. 10. In an example illustrated in FIG. 10, the CPU 10 displays the mark 57 more conspicuously than the mark 56, according to the instruction of the display aspect, so that the user can know intuitively that the favorite store shown by the mark 57 is a store that is likely to be a favorite store of the celebrity A.

In the example illustrated in FIG. 10, when the marks 56 and 57 or the displays of “favorites of the celebrity A” displayed on the map are selected, the CPU 10 may perform control to display the detailed information of the favorite store.

### (Complement 3)

In the favorite information acquisition system according to this embodiment, the user may be guided to the favorite store, on the basis of the acquired favorite information. Specifically, when a captured image output from the camera module 18 is displayed as a through image in real time on the display unit 16 of the client terminal 1, if the previously registered favorite store of the specific person is in an angle of view (through image), the CPU 10 performs marking on the screen, displays an icon, or display a full name of the specific person to notify the user of corresponding information.

The CPU 10 may determine whether the favorite store is in the angle of view (through image), on the basis of the analysis of the through image, the current position information, and the acquired favorite information (the position information, the thumbnail image, and the like of the favorite store).

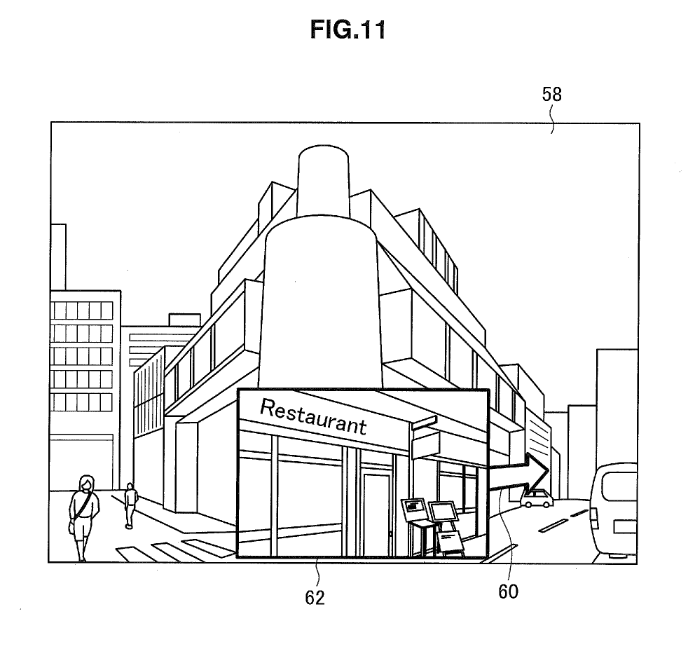

If the favorite store is out of the angle of view, the CPU 10 may display an arrow according to a direction where the favorite store is positioned on the through image and guide the user. For example, as illustrated in FIG. 11, the CPU 10 displays a thumbnail image 62 of the favorite store and an arrow 60 according to the direction where the favorite store is positioned on a through image 58 and guides the user. In this case, the CPU 10 may acquire imaging direction information from a direction sensor (not illustrated in the drawings) of the client terminal 1 and determine the direction where the favorite store is positioned, on the basis of the through image, the current position information, and the acquired favorite information (position information and the like of the favorite store).

When the favorite store is out of the angle of view, the CPU 10 may guide the user to the direction where the favorite store is positioned, by using a sound, a vibration, and an electric stimulus in addition to the display of the arrow 60.

### (Complement 4)

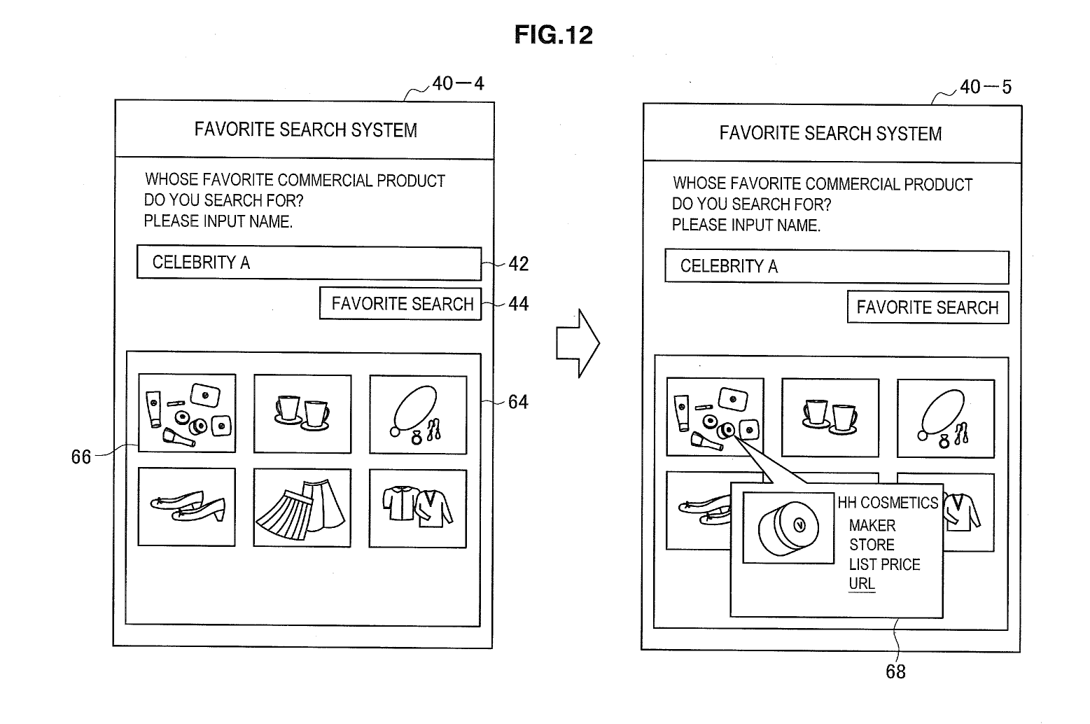

The display example of the favorite information when the information regarding the favorite “store” is acquired has been described. However, as described above, the attention object of the certain person is not limited to the store and may be a commercial product, an event, a spot, and the like. Therefore, a display example when information regarding a favorite “commercial product” is acquired will be described below with reference to FIG. 12.

FIG. 12 is a diagram illustrating a display example of favorite commercial products according to this embodiment. If the CPU 10 of the client terminal 1 acquires favorite commercial product information of a specific person (for example, a celebrity A) designated by a user, the CPU 10 displays thumbnail images of favorite commercial products in a commercial product display region 64, as in a result screen 40-4 illustrated at the left side of FIG. 12.

When a thumbnail image 66 of the favorite commercial product displayed in the commercial product display region 64 is selected, the CPU 10 may perform control such that the detailed information of the favorite commercial product is displayed by a balloon display 68, as in a result screen 40-5 illustrated at the right side of FIG. 12. In the balloon display 68, names, makers, stores, list prices, and the like of the favorite commercial products are included, as illustrated in FIG. 12.

### <4. CONCLUSION>

As described above, in the favorite information acquisition system according to this embodiment, the favorite information of the specific person can be provided on the basis of the evaluation with respect to the attention object candidate.

It should be understood by those skilled in the art that various modifications, combinations, sub-combinations and alterations may occur depending on design requirements and other factors insofar as they are within the scope of the appended claims or the equivalents thereof.

For example, in the favorite information acquisition system according to this embodiment, the searching unit 220 may search for the information regarding the plurality of specific persons designated by the user and the evaluating unit 230 may evaluate the attention objects, on the basis of the plurality of search results. Thereby, the user can know the favorite stores or commercial products of the plurality of celebrities whom the user likes.

Additionally, the present technology may also be configured as below:
(1) An information processing apparatus including:

a first managing unit that manages specific person information, the specific person information being information regarding a specific person;

a second managing unit that manages attention object information, the attention object information being information regarding an attention object candidate;

a searching unit that searches for the specific person information, using the attention object information as a search key;

an evaluating unit that evaluates an attention object, on the basis of a search result obtained by the searching unit; and

a storage control unit that stores the specific person, the attention object, and an evaluation value obtained by the evaluating unit in association with each other.
(2) The information processing apparatus according to (1),

wherein the evaluating unit performs weighting according to the specific person information to evaluate the attention object.
(3) The information processing apparatus according to (1) or (2),

wherein the evaluating unit evaluates the attention object, on the basis of how many times the attention object information is searched for in the specific person information by the searching unit.
(4) The information processing apparatus according to (3),

wherein the evaluating unit performs a plus/minus evaluation.
(5) The information processing apparatus according to any one of (1) to (4),

wherein the specific person includes a celebrity.
(6) The information processing apparatus according to any one of (1) to (5),

wherein the specific person information includes an address of a Web page that provides the information regarding the specific person.
(7) The information processing apparatus according to any one of (1) to (6),

wherein the attention object information is store information, event information, spot information, or commercial product information.
(8) The information processing apparatus according to any one of (1) to (7),

wherein the evaluating unit performs weighting according to a provider of the specific person information to evaluate the attention object.
(9) The information processing apparatus according to any one of (1) to (8),

wherein the searching unit searches for a recommendation/use history of the attention object in the specific person information.
(10) The information processing apparatus according to any one of (1) to (9),

wherein the searching unit searches for the specific person information of a plurality of specific persons, and

wherein the evaluating unit evaluates the attention object, on the basis of a plurality of search results obtained by the searching unit.
(11) The information processing apparatus according to any one of (1) to (10), further including:

a transmission control unit that performs control to transmit information to display the attention object, on the basis of the evaluation value of the attention object stored in association with the specific person designated from a client terminal.
(12) The information processing apparatus according to (11),

wherein, when the evaluation value is more than a predetermined value, the transmission control unit performs control to transmit the information to display the attention object.
(13) The information processing apparatus according to (11) or (12),

wherein the transmission control unit performs control to transmit information to display the attention object on a map, on the basis of position information included in the attention object information.
(14) The information processing apparatus according to any one of (11) to (13),

wherein the transmission control unit performs control to transmit information to display the attention object displayed in a different aspect according to whether the evaluation value is more than a first predetermined value or a second predetermined value.
(15) The information processing apparatus according to any one of (1) to (14), further including:

a transmission control unit that transmits information to guide a user to a position of the attention object, on the basis of the evaluation value of the attention object stored in association with the specific person designated from a client terminal.
(16) A recording medium having a program recorded thereon, the program causing a computer to execute:

a process of managing specific person information, the specific person information being information regarding a specific person;

a process of managing attention object information, the attention object information being information regarding an attention object candidate;

a process of searching for the specific person information, using the attention object information as a search key;

a process of evaluating an attention object, on the basis of a search result obtained in the process of searching for the specific person information; and

a process of storing the specific person, the attention object, and an evaluation value obtained in the process of evaluating the attention object in association with each other.

The present disclosure contains subject matter related to that disclosed in Japanese Priority Patent Application JP 2012-135671 filed in the Japan Patent Office on Jun. 15, 2012, the entire content of which is hereby incorporated by reference.

What is claimed is:

1. An information processing apparatus comprising:
a first managing unit that manages specific person information, the specific person information being information regarding a specific person;
a second managing unit that manages attention object information, the attention object information being information regarding an attention object candidate;
a searching unit that searches for the specific person information, using the attention object information as a search key;
an evaluating unit that evaluates an attention object, on the basis of a search result obtained by the searching unit; and
a storage control unit that stores the specific person, the attention object, and an evaluation value obtained by the evaluating unit in association with each other.

2. The information processing apparatus according to claim 1,
wherein the evaluating unit performs weighting according to the specific person information to evaluate the attention object.

3. The information processing apparatus according to claim 1,
wherein the evaluating unit evaluates the attention object, on the basis of how many times the attention object information is searched for in the specific person information by the searching unit.

4. The information processing apparatus according to claim 3,
wherein the evaluating unit performs a plus/minus evaluation.

5. The information processing apparatus according to claim 1,
wherein the specific person includes a celebrity.

6. The information processing apparatus according to claim 1,
wherein the specific person information includes an address of a Web page that provides the information regarding the specific person.

7. The information processing apparatus according to claim 1,
wherein the attention object information is store information, event information, spot information, or commercial product information.

8. The information processing apparatus according to claim 1,
wherein the evaluating unit performs weighting according to a provider of the specific person information to evaluate the attention object.

9. The information processing apparatus according to claim 1,
wherein the searching unit searches for a recommendation/use history of the attention object in the specific person information.

10. The information processing apparatus according to claim 1,
wherein the searching unit searches for the specific person information of a plurality of specific persons, and
wherein the evaluating unit evaluates the attention object, on the basis of a plurality of search results obtained by the searching unit.

11. The information processing apparatus according to claim 1, further comprising:
a transmission control unit that performs control to transmit information to display the attention object, on the basis of the evaluation value of the attention object stored in association with the specific person designated from a client terminal.

12. The information processing apparatus according to claim 11,
wherein, when the evaluation value is more than a predetermined value, the transmission control unit performs control to transmit the information to display the attention object.

13. The information processing apparatus according to claim 11,
wherein the transmission control unit performs control to transmit information to display the attention object on a map, on the basis of position information included in the attention object information.

14. The information processing apparatus according to claim 11,
wherein the transmission control unit performs control to transmit information to display the attention object displayed in a different aspect according to whether the evaluation value is more than a first predetermined value or a second predetermined value.

15. The information processing apparatus according to claim 1, further comprising:
a transmission control unit that transmits information to guide a user to a position of the attention object, on the basis of the evaluation value of the attention object stored in association with the specific person designated from a client terminal.

16. A recording medium having a program recorded thereon, the program causing a computer to execute:
a process of managing specific person information, the specific person information being information regarding a specific person;
a process of managing attention object information, the attention object information being information regarding an attention object candidate;
a process of searching for the specific person information, using the attention object information as a search key;
a process of evaluating an attention object, on the basis of a search result obtained in the process of searching for the specific person information; and
a process of storing the specific person, the attention object, and an evaluation value obtained in the process of evaluating the attention object in association with each other.
